(19) United States
(12) Patent Application Publication
(10) Pub. No.: US 2013/0262561 A1
(43) Pub. Date: Oct. 3, 2013

(54) Invention of Self-Creating Communication Center

(71) Applicant: Qiuhang Qian, Marble Falls, TX (US)

(72) Inventor: Qiuhang Qian, Marble Falls, TX (US)

(21) Appl. No.: 13/492,063

(22) Filed: Jun. 8, 2012

Related U.S. Application Data
(60) Provisional application No. 61/618,696, filed on Mar. 31, 2012.

(51) Int. Cl. G06F 15/16

(52) U.S. Cl. 709/203

(57) ABSTRACT

Revolutionary self-creating communication center is invented. Any company and organization that intend to improve their internal communication or move the current communication to the next level can create the uniquely designed communication center by themselves online. The communication center will be established after they follow each design step. The web-based self-creating communication center and non web-based version are made up of different modules. Each module has its own process design layout and functionality. The layout and process functionality will help the company and the organization create the communication center online by themselves. These modules include the business account, information database for the business to select, design tools, stages of services selection and contents creation, test, modification, confirmation, online payment, billing, export and technical support etc. Each module is developed with programs. The programs are stored on the server and created separately on the storage device. They can be transferred and exported to the company and organization's legacy systems. The company and organization can change and modify the communication center anytime.

### CROSS REFERENCE TO RELATED APPLICATIONS

Not Applicable

### STATEMENT OF FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM

In The Development

### BACKGROUND OF THE INVENTION

Every company and organization needs communication to help run their company and organization. Some companies and organizations have better communication, some others don't. Successful companies are successful partly due to their effective communication. The poor performance companies usually have communication issues. These communication issues could occur between co-workers, employees and managers, managers and managers etc. Some large companies on the other hand become more and more difficult to communicate because of their sizes. These companies may have several subsidiaries or even more. The employees and the management may not know quickly what happens in the headquarter or in the subsidiaries. Managers' decisions sometimes are not clearly or quickly known as the records shown in the public place for anyone to view. The senior management may not know how much the progress their lower ranked managers are making The managers know little between themselves. Management board's direction may be delayed to pass to the right places at the right time. Therefore the right decisions could be missed or delayed. And the communication channel doesn't look very effective.

The current company and organization's communication are done mainly through email, internal phone call and meeting. These traditional communication tools have been used for long time to help run the daily activities. Self-creating communication center targets the companies and organizations that feel they need more effective communication to help run their organization. The features and functionality of the communication center are new and unique in the marketplace. No one has developed the same communication center. It moves all the physical departments online and provides many useful tools for communication no matter how many subsidiaries the company has. Even the companies who have good communication can try and use it. The self-creating communication center is easy to create. Any business can build it by following the steps that are pre-designed and developed.

### BRIEF SUMMARY OF THE INVENTION

The web-based communication center is intended for the company and any organization to create it by themselves online. Any company and organization can log onto the host company's website and build the communication center for their organization. The company and organization can be small or large with subsidiaries or without subsidiaries. There are different steps pre-designed and developed for them to go through. These steps include 1). Creating business account; 2). Service selection 1; 3) Service selection 2; 4). Service selection 3; 5). Layout design; 6). Preview; 7). Save; 8). Service selection 4 and create; 9). Test; 10). Modify; 11). Preview; 12). Save; 13). Service selection 5 if any; 14). Payment selection; 15). Pay; 16). Verify; 17). Export; 18). Configure; 19) Apply. These steps are developed by using the computer language. The steps are compiled as packages that are stored within the web-based communication center. They will be invoked when they are triggered. The company and the organization follow each step before they finish building the communication center. The company and the organization can modify it online at anytime. The most advantage of the self-creating communication center is its easy creating process that enables the company and organization to build online by themselves. The features and functionality of the communication center are very uniquely designed. Most of them are not available in the market in terms of communication tool package. It moves all the physical departments online and provides many useful and interesting tools for communication within the company and between subsidiaries.

### SEVERAL VIEWS OF THE DRAWING (IF ANY)

FIG. 1 is the process diagram illustrating how technically the communication center is created and built online by the business or the organization itself.

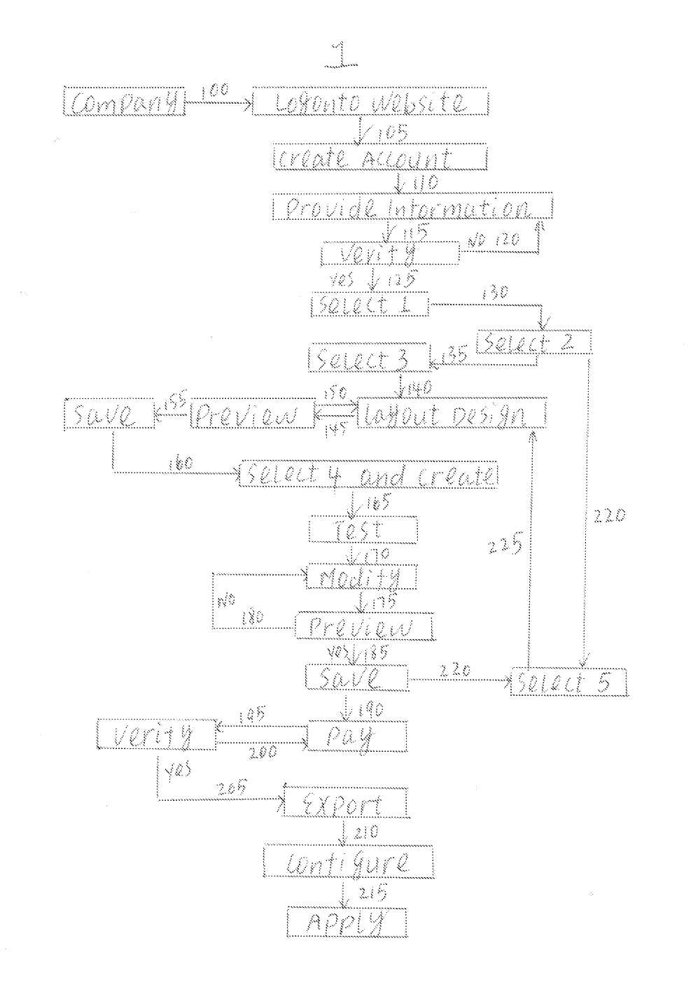

1. The Invention of Self-Creating Communication Center
